(19) United States
(12) Patent Application Publication
(10) Pub. No.: US 2007/0107391 A1
(43) Pub. Date: May 17, 2007

(54) Filtration device with a filter bag and a cleaning device for a filter bag

(76) Inventor: Christian Reining, Sendenhorst (DE)

Correspondence Address: COHEN, PONTANI, LIEBERMAN & PAVANE, 551 FIFTH AVENUE, SUITE 1210, NEW YORK, NY, 10176, US

(21) Appl. No.: 11/274,970

(22) Filed: Nov. 16, 2005

(51) Int. Cl. B01D 46/04

(52) U.S. Cl. 55/302

(57) ABSTRACT

A filtration device having at least one filter bag between a crude gas side and a clean gas side, and a cleaning device for cleaning the filter bag. Each filter bag has a bag body with a longitudinal axis and a first end with a bag opening. The cleaning device has a nozzle head with a plurality of nozzles, the operation of which causes the cleaning device to rotate, and wherein the cleaning device can be moved in the longitudinal direction of each filter bag during operation of the nozzles. During the operation of the nozzles, the cleaning device generates a pressure wave in the bag body, and this pressure wave propagates from the bag opening to a free end of the bag body.

### BACKGROUND OF THE INVENTION

1. Field of the Invention

The present invention relates to a filtration device having at least one filter bag between a crude gas side and a clean gas side. Each filter bag has a bag body with a longitudinal axis and a first end with a bag opening, as well as a cleaning device for cleaning the filter bag. The cleaning device has a nozzle head with a plurality of nozzles, the operation of which causes the cleaning device to rotate, and wherein the cleaning device can be moved in the longitudinal direction of each filter bag during operation of the nozzles.

2. Description of the Related Art

U.K. Patent Application No. GB 1,184,784 describes a cleaning device for cleaning a filter screen, i.e., a “hard” filter element. The cleaning is accomplished by rinsing off the inner surface of the filter screen by means of a rotating nozzle assembly. The nozzle assembly delivers a jet of water for cleaning the filter screen.

German Patent Application No. DE 39 20 097 describes a similar filtration device for cleaning filter canisters. Filter canisters of this type are produced from a pleated filter material, i.e., they are stiffened and folded. The cleaning gas strikes the inside of the filter material and mechanically dislodges contaminants.

In both cases, successful cleaning depends exclusively on a singular event at the point of impact of the cleaning agent on the “hard” filter material of the filter canister or filter screen.

In contrast to filter canisters and filter screens, filter bags are composed of a much more flexible material, which can elude mechanical impact much more readily than the material of a filter canister or filter screen. Therefore, cleaning with cleaning devices of the cited prior art is much less successful in this case.

Filter bags cannot be mechanically cleaned very well by the means described above. However, the contaminants, i.e., the filter cake, retained on the body or wall of the bag must be removed from the body of the bag from time to time to maintain the cleaning effect of the filter bag.

Cleaning methods for cleaning of this type are already known. In one method, a nozzle is arranged above the filter bag and directs a so-called “jet pulse” into the filter bag obliquely to a longitudinal axis, so that the body of the bag is caused to undulate or vibrate. This is designed to shake the filter cake from the body of the bag. This type of jet pulse occurs in an uncontrolled way, with the result that satisfactory cleaning is not obtained in all parts of the bag.

Alternatively, a nozzle lance into the body of the bag. However, a nozzle lance frequently damages the body of the bag, e.g., by cutting it open so that time-consuming operations become necessary to replace the damaged filter bag with a new one. The same problem is encountered with the use of the nozzle head, which is mounted on one end of a flexible hose as described in U.S. Pat. No. 5,182,832. This device can easily damage the sensitive filter material as it moves.

A third variant for cleaning a filter bag of this type is to remove the filter bag and have it cleaned in either a dry or wet cleaning operation.

All of the above methods for cleaning filter bags are unsatisfactory because they either do not work carefully enough, are cost-intensive, or are technically complex.

### SUMMARY OF THE INVENTION

An object of the present invention is to develop a filtration device of the aforesaid type that ensures satisfactory cleaning of the coating that is deposited on a filter bag.

This object is achieved by means of a pressure wave generated in the body of the bag by the cleaning device during the operation of the nozzles and propagating from the opening of the bag to a free end of the body of the bag.

The filtration device of the present invention guarantees reliable cleaning of a filter bag. The cleaning device can have a nozzle head which is moved in a filter bag or along a filter bag, parallel to it. The delivery of a pressurized fluid at a certain position in the longitudinal direction ensures that every region of the body of the bag is reliably reached, and damage to the body of the bag is avoided. Finally, the detachable mounting possibility allows variable mounting and arrangement of nozzles, depending on the material and the degree of contamination.

The cleaning device of the invention does not blow against the filter bags or blow off the filter dust, but rather filter media made of relatively soft material (e.g., filter bags) are excited to natural-frequency vibration by high rotational speeds, e.g., greater than 10,000 rpm, which causes them to shake and causes the filter dust to fall off.

The cleaning effect is better than what can be achieved by removing and washing the filter medium, since during washing, the finish and the felt composite are subjected to considerable stress and partially detached and lost.

Another advantage is that each nozzle has one nozzle orifice, and at least two nozzles differ with respect to their orifice cross section.

Filter bags can be coated with different dusts and thus have different natural frequencies. For this reason, a frequency band including the natural frequency of the dust-covered filter bag can be obtained by nozzles with orifices of different orifice widths and/or angles.

In the case of sensitive composite materials, e.g., membrane filters, there is the danger that the membrane will become detached from the felt or delaminated from the composite material. For this reason, it is advantages in these cases to arrange a grid construction that consists of a perforated plate, grating bars or the like in front of the rotating part of the nozzle head. In this way, the jet of pressurized fluid directed at the filter bag is broken and diffusely directed at the material of the filter bag. This amplitude of the natural-frequency vibration can be significantly reduced by this measure.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

A specific embodiment of the present invention is described in greater detail below with reference to the drawings in which:

FIG. 1 shows a schematic view of a filtration device in longitudinal section with a cleaning device guided in a filter bag.

FIG. 2 shows a top view of a group of filter bags with several cleaning devices.

FIG. 3 shows a schematic representation of a nozzle head with receptacles for the variable arrangement of nozzles in accordance with the present invention.

FIG. 4a shows a schematic side view of a first version of a variable nozzle.

FIG. 4b shows a schematic top view of the variable nozzle in FIG. 4a with a circular opening as the nozzle orifice.

FIG. 5a shows a schematic side view of a second version of a variable nozzle.

FIG. 5b shows a schematic top view of the variable nozzle in FIG. 5a with a slot opening as the nozzle orifice.

FIG. 6a shows a schematic side view of a third version of a variable nozzle.

FIG. 6b shows a schematic top view of the variable nozzle in FIG. 6a with a star-shaped opening as the nozzle orifice.

FIG. 7 shows a schematic side view of the nozzle head with a screen for membrane composite filters.

### DETAILED DESCRIPTION OF THE PRESENTLY PREFERRED EMBODIMENTS

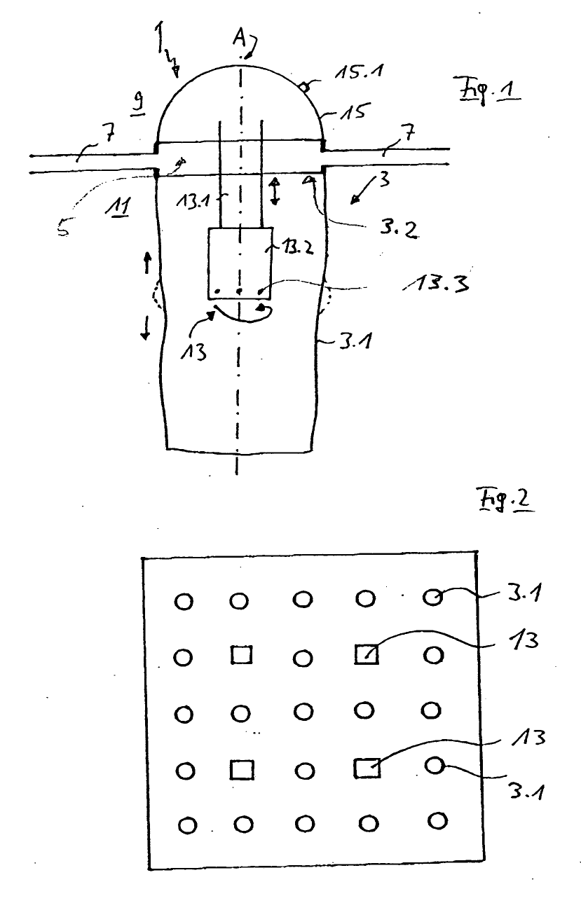

FIG. 1 shows a schematic view of a filtration device 1 in longitudinal section. The filtration device 1 comprises a filter bag, which has a bag body 3.1 or bag wall that is clamped in an opening 5 of a top plate 7. This clamp mounting results in a bag opening 3.2 over essentially the entire cross section of the clamped bag body 3.1. A clean gas side 9 is located above the top plate 7, and a so-called crude gas side is located below the top plate 7.

A cleaning device 13 (shown in detail in FIG. 3) hangs through the bag opening 3.2 and is suspended in the bag body 3.1. In other embodiments, the cleaning device 13 can also be inserted from the crude gas side 11 or from below. The cleaning device 13 comprises essentially a rod-shaped support 13.1 and a nozzle head 13.2 on a free end that extends into the bag body 3.1 along the longitudinal axis of the bag body 3.1. FIG. 1 shows how a plurality of nozzles 13.3 is provided on the nozzle head 13.2. The nozzles 13.3 are arranged tangentially with respect to the nozzle head 13.2. When a pressurized fluid is ejected from the nozzles 13.3, the nozzle head 13.2 rotates on the rod-shaped element 13.1, or the nozzle head 13.2 rotates together with the rod-shaped element 13.1. The direction of rotation is schematically shown by an arrow in FIG. 1.

The nozzles 13.3 are tightly but detachably inserted in receptacles 13.4 formed in the periphery or the lateral surface 13.5 of the nozzle head 13.2. In the present embodiment, the receptacles 13.4 have an internal thread 13.6, and the nozzles have an external thread 13.7 that matches the internal thread 13.6. The individual nozzles 13.3 can thus be optionally screwed into or out of the nozzle head. In other embodiments, however, other connecting or fastening techniques can be used. For example, it is possible to use plug connectors.

In other embodiments, the nozzle head 13.2 is divided into nozzle rings (not shown), and the tangential orientation of the nozzles 13.3 with respect to adjacent nozzle rings is in the opposite or same direction. When a pressurized fluid is ejected from the nozzles 13.3, the individual nozzle rings are thus caused to rotate in opposite directions.

In the embodiment shown in FIG. 1, a gaseous pressurized fluid, e.g., compressed air, is discharged from the nozzles 13.3. The discharge of compressed air from the nozzles 13.3 exerts pressure on the inside wall of the bag body 3.1, and this pressure pushes the bag body 3.1 outward and causes it to vibrate at its natural frequency. The cleaning device 13 has a longitudinal axis, which approximately coincides with or runs parallel to a longitudinal axis of the clamped bag body 3.1. The cleaning device 13 is arranged on this longitudinal axis in such a way that it can be moved back and forth along the entire length of the bag body 3.1. When the pressurized fluid or the compressed air is discharged from the nozzles 13.3, as the cleaning device 13 moves in the longitudinal direction, a controlled pressure wave is generated in the bag body 3.1. This pressure wave propagates from the top, i.e., from the point at which the bag body is clamped on the top plate 7, towards the bottom, i.e., towards the free end of the filter bag 3. Depending on the number of nozzles 13.3 in a horizontal plane, undulations simultaneously propagate concentrically in the peripheral region of the bag body 3.1 on which the compressed air is acting. The nozzles 13.3 can be variably mounted in the receptacles 13.4 on the periphery of the nozzle head 13.2 and can have different nozzle orifices 13.5, e.g., nozzle orifices with different geometries and orifice widths. The following are examples of designs of the nozzle orifices 13.5: circular, oval, or polygonal orifice cross sections, slot-shaped orifices with one or more parallel slots, and star-shaped orifices. Additionally, or alternatively, the nozzles 13.3 can be arranged at different angles with respect to the filter bag 3. A frequency band in which the natural frequency of the dust-covered filter bag is located can be covered by this variation of the nozzles 13.3.

Depending on the speed of rotation (approximately greater than 10,000 rpm) of the nozzle head 13.2 or the nozzle rings (not shown), and depending on the number of nozzles 13.3, the undulatory motion becomes a controlled vibration, with which filtered material adhering to the outside of the bag body 3.1 can be shaken off. For membrane composite filters, a grid construction or screen 13.9 (as shown in FIG. 7) is arranged in front of the rotating part of the nozzle head 3.2 to diffusely direct the pressurized fluid at the filter bag and reduce the amplitude of the natural-frequency vibration.

Referring to FIG. 1, a bell-shaped top 15 is optionally formed on the clean gas side 9 above the bag opening 3.2. The bell-shaped top 15 has a connection 15.1 for sucking out dust from the inside. The cleaning device 13 can also be operated with a liquid pressurized fluid. In this mode of operation, the cleaning device is not arranged in a bag body 3.1 and moved in the longitudinal direction but rather alongside a bag body 3.1. FIG. 2 shows a top view of a group of filter bags 3 with bag bodies 3.1. Individual filter bags can be removed from this group of filter bags 3, and each removed filter bag can be replaced by a cleaning device 13. It is practical to remove central filter bags 3 so that the cleaning devices 13 with which they are replaced are surrounded by the remaining filter bags 3. The cleaning devices 13 are then moved in the longitudinal direction as described above and are operated with a liquid or gaseous pressurized fluid in such a way that the nozzle head 13.2 rotates. In this embodiment as well as in other embodiments, it is possible to use nozzle rings with the opposite or same directions of rotation and with the same or different rotational speeds. In this way, the surrounding bag bodies 3.1 can be washed with the liquid pressurized fluid.

FIG. 2 shows a schematic top view of a group of filter bags 3 with several cleaning devices 13 without a bell-shaped top 15. The bag body 3.1 of each filter bag 3 is shown as circular in FIG. 2. The four cleaning devices 13 in the present example are shown as squares. The cleaning devices 13 can be moved over the filter bags 3 in such a way that each bag body 3.1 can be reached and cleaned by the cleaning devices. Each nozzle head 13.2 can be introduced into a bag body 3.1 by means of a drive (not shown) that drives the rod-shaped support 13.1. To accelerate the cleaning process, it is also possible to introduce several nozzle heads 13.2, e.g., the four nozzle heads 13.2 shown in FIG. 2, simultaneously into the four associated bag bodies 3.1 by means of a common drive.

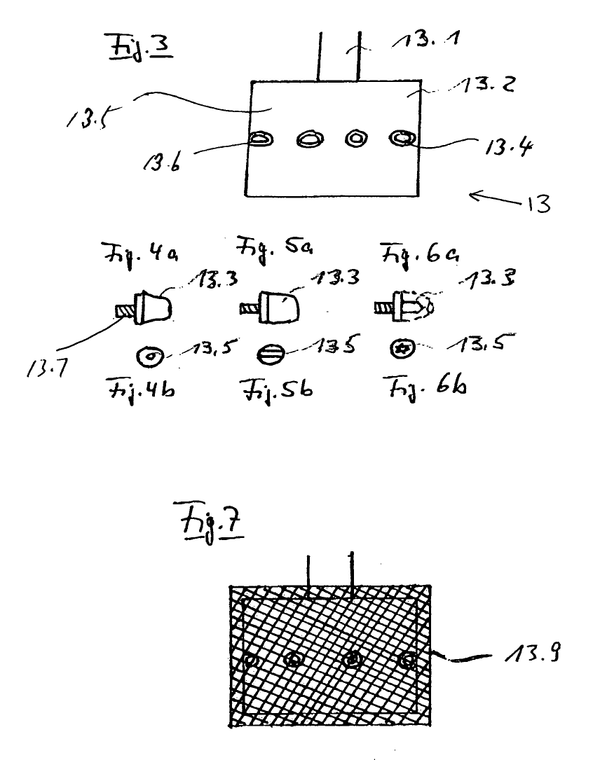

FIGS. 4a and 4b show a nozzle 13.3 with a circular nozzle orifice 13.5, FIGS. 5a and 5b show a nozzle 13.3 with a slot-shaped nozzle orifice 13.5, and FIGS. 6a and 6b show a nozzle 13.3 with a star-shaped nozzle orifice 13.5. The geometries of the nozzle orifices 13.5 that are described here are merely examples. Actually, the nozzle orifices 13.5 can have a geometry that produces the jet characteristics necessary for the natural-frequency vibration. These jet characteristics of the discharged pressurized fluid can be determined in individual cases by tests on soiled filter bags.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A filtration device comprising:
a filter bag having a bag body and suitable to be positioned between a crude gas side and a clean gas side, the bag body having a longitudinal axis, a first end, an opposite second end, and a bag opening at the first end;
a cleaning device for cleaning the filter bag, the cleaning device comprising:
a nozzle head; and
a plurality of nozzles mounted on the nozzle head, operation of the nozzles causing the nozzle head to rotate,
wherein the cleaning device can be moved along the longitudinal axis and generates a pressure wave in the bag body during the operation of the nozzles, and wherein the pressure wave propagates from the bag opening to the second end of the bag body.

2. The filtration device of claim 1, wherein each of the nozzles has a nozzle orifice having an orifice cross section, and wherein at least two nozzles have different shaped orifice cross sections.

3. The filtration device of claim 2, wherein the orifice cross sections are circular, slot-shaped or star-shaped.

4. The filtration device of claim 3, wherein the nozzle head has a plurality of threaded nozzle receptacles, and at least one of the nozzles has an external threading sized to be screwed into one of the threaded nozzle receptacles.

5. The filtration device of claim 1, wherein the nozzle head has a plurality of threaded nozzle receptacles, and at least one of the nozzles has an external threading sized to be screwed into one of the threaded nozzle receptacles.

6. The filtration device of claim 1, wherein the cleaning device extends into the filter bag through the bag opening and can be moved back and forth along the longitudinal axis.

7. A filtration device comprising:
a plurality of filter bags each having a bag body, each of the bag bodies having a longitudinal axis, a first end, an opposite second end, and a bag opening at the first end, the filter bags being parallel to and spaced from each other; and
a cleaning device for cleaning the filter bags, the cleaning device comprising:
a nozzle head; and
a plurality of nozzles mounted on the nozzle head, operation of the nozzles causing the nozzle head to rotate,
wherein the cleaning device is surrounded by the filter bags and can be moved back and forth along a direction parallel to the longitudinal axes.

8. The filtration device of claim 1, wherein the nozzle head has a lateral surface, and the nozzles are arranged essentially tangentially to the lateral surface of the nozzle head and generate the pressure wave in the bag body, the pressure wave propagating in the bag body in a direction of movement of the cleaning device.

9. The filtration device of claim 1, wherein the cleaning device generates the pressure wave by using a pressurized fluid.

10. The filtration device of claim 9, wherein the pressurized fluid is a gas.

11. The filtration device of claim 9, wherein the pressurized fluid is a liquid.

12. The filtration device of claim 1, further comprising a screen arranged between the nozzle head and the filter bag.
